(19) United States
(12) Patent Application Publication
(10) Pub. No.: US 2026/0048326 A1
(43) Pub. Date: Feb. 19, 2026

(54) POSITION INFORMATION DISPLAY METHOD AND APPARATUS, AND ELECTRONIC DEVICE

(71) Applicant: NETEASE (HANGZHOU) NETWORK CO., LTD., Hangzhou, Zhejiang (CN)

(72) Inventor: Yangchen JIANG, Hangzhou, Zhejiang (CN)

(73) Assignee: NETEASE (HANGZHOU) NETWORK CO., LTD., Hangzhou, Zhejiang (CN)

(21) Appl. No.: 18/995,946

(22) PCT Filed: Feb. 3, 2023
(86) PCT No.: PCT/CN2023/074339

§ 371 Date: Jan. 17, 2025

(30) Foreign Application Priority Data
Jul. 20, 2022 (CN) 202210862678.5

(51) Int. Cl. A63F 13/5372; A63F 13/837

(52) U.S. Cl. CPC A63F 13/5372; A63F 13/837

(57) ABSTRACT

A position information display method and apparatus, and an electronic device. The method comprises: displaying on a graphical user interface an area monitoring identifier, the area monitoring identifier comprising a plurality of area identifiers; determining a target virtual object, and acquiring target position information of the target virtual object in a game scene; determining a target area identifier among the plurality of area identifiers according to the target position information, determining a display mode of the target area identifier according to height information in the target position information, and, according to the display mode, displaying the target area identifier.

### CROSS REFERENCE TO RELATED APPLICATIONS

The present disclosure claims the priority of the Chinese patent application with an application number of 202210862678.5, filed on Jul. 20, 2022, and titled by “Method and apparatus for displaying position information, and electronic device”, the entire contents of which are incorporated herein by reference.

### TECHNICAL FIELD

The present disclosure relates to the technical field of game, and in particular, to a method and apparatus, for displaying position information, and an electronic device.

### BACKGROUND

In shooting games, when a player's virtual character is hit, a hit marker is usually displayed within the player's field of vision to indicate the source of the hit, that is, the position of the enemy virtual character that hits the player's virtual character, for example, an arrow or arc-shaped marker, etc. is displayed to indicate the position of the enemy virtual character. The hit marker can help the player predict the position of the enemy. However, the above-mentioned hit marker can only indicate the approximate position of the enemy, and cannot accurately provide the specific position of the enemy, which is not conducive to the player's decision-making in the game and affects the game experience of the player.

### SUMMARY

In view of this, the purpose of the present disclosure is to provide a method and apparatus for displaying position information, and an electronic device, so as to display the orientation information, distance information and height information between virtual objects within the target monitoring range in the game scene through a plurality of area markers of the area monitoring marker, thereby determining the specific positions of the virtual objects, which is conducive to the player making decisions in the game and improving game experience of the player.

In a first aspect, an embodiment of the present disclosure provides a method for displaying position information. A graphical user interface is displayed by a terminal device, the graphical user interface includes a scene screen of a game scene and a first virtual object located in the game scene, and the first virtual object is a virtual object controlled by the terminal device. The method includes: displaying an area monitoring marker on the graphical user interface, where a monitored area corresponding to the area monitoring marker is a spatial area of the game scene determined according to a current position of the first virtual object and a monitoring range parameter, the area monitoring marker includes a plurality of area markers, and the area marker corresponds to a scene area within a range of target monitoring direction and a range of target monitoring distance in the game scene; determining a target virtual object, and obtaining target position information of the target virtual object in the game scene, where the target virtual object is a virtual object other than the first virtual object in the game scene; determining a target area marker from the plurality of area markers according to the target position information, where a scene area within the range of target monitoring directions and the range of target monitoring distances corresponding to the target area marker matches the target position information; and determining a display mode of the target area marker according to height information in the target position information, and displaying the target area marker according to the display mode.

Further, a step of determining the target virtual object includes: determining a candidate virtual object that performs a preset game behavior, and obtaining orientation information of the candidate virtual object; when the orientation information of the candidate virtual object is within the monitored area, determining the candidate virtual object as the target virtual object.

Further, the target position information is absolute position information of the target virtual object relative to the game scene, and the absolute position information includes at least one of following information: horizontal position information and height position information; or, the target position information is relative position information of the target virtual object relative to the first virtual object, and the relative position information includes at least one of following information: relative distance information, relative orientation information and relative height information.

Further, a step of determining the target area marker from the plurality of area markers according to the target position information includes: determining the target area marker from the plurality of area markers according to horizontal position information, or relative distance information and relative orientation information in the target position information.

Further, the plurality of area markers includes a first area marker; and a step of determining the target area marker from the plurality of area markers according to the horizontal position information, or the relative distance information and the relative orientation information in the target position information includes: if the horizontal position information or the relative distance information indicates that a horizontal distance between the target virtual object and the first virtual object is less than or equal to a first preset distance, determining the first area marker as the target area marker.

Further, the plurality of area markers includes a plurality of second area markers, and each of the second area markers has a different relative direction to a center point of the first area marker; and the step of determining the target area marker from the plurality of area markers according to the horizontal position information, or the relative distance information and the relative orientation information in the target position information includes: if the horizontal position information or the relative distance information indicates that a horizontal distance between the target virtual object and the first virtual object is greater than a first preset distance and less than or equal to a second preset distance, determining the second area markers as first candidate area markers; and if the horizontal position information or the relative orientation information indicates that an orientation of the target virtual object relative to the first virtual object is a first direction, determining the target area marker that matches the first direction from the first candidate area markers.

Further, the plurality of area markers includes a plurality of third area markers, and each of the third area markers has a different relative direction to a center point of the first area marker; and the step of determining the target area marker from the plurality of area markers according to the horizontal position information, or the relative distance information and the relative orientation information in the target position information includes: if the horizontal position information or the relative distance information indicates that a horizontal distance between the target virtual object and the first virtual object is greater than a second preset distance and less than or equal to a third preset distance, determining the third area markers as second candidate area markers; and if the horizontal position information or the relative orientation information indicates that an orientation of the target virtual object relative to the first virtual object is a second direction, determining the target area marker that matches the second direction from the second candidate area markers.

Further, the area monitoring marker is a first circle, a first area marker in the plurality of area markers is a second circle, a radius of the first circle is greater than a radius of the second circle, and a center of the first circle is at a same position as a center of the second circle; second area markers in the plurality of area markers are sectors divided from a circular ring between the first circle and the second circle; and third area markers in the plurality of area markers are outer lines of the first circle.

Further, the area monitoring marker is provided with a reference position marker, and the reference position marker corresponds to the first virtual object; and a step of determining the display mode of the target area marker according to the height information in the target position information, and displaying the target area marker according to the display mode includes: determining the display mode of the target area marker according to height position information or relative height information in the target position information, and displaying a first position marker of the target virtual object in the target area marker according to the display mode, where the first position marker is used to indicate the target position information of the target virtual object relative to the first virtual object, and a relative position of the first position marker to the reference position marker matches a relative position of the target virtual object to the first virtual object.

Further, the target area marker is a first area marker, and the reference position marker is located at the first area marker; and a step of determining the display mode of the target area marker according to the height position information or the relative height information in the target position information, and displaying the first position marker of the target virtual object in the target area marker according to the display mode includes: if the height position information or the relative height information indicates that a height difference between the target virtual object and the first virtual object is zero, and a relationship between the target virtual object and the first virtual object is a hostile relationship, filling the target area marker with a first preset color that is highlighted at an edge and transparent to the interior; and if the height position information or the relative height information indicates that the height difference between the target virtual object and the first virtual object is not zero, and the relationship between the target virtual object and the first virtual object is the hostile relationship, displaying a line with the first preset color at the edge of the target area marker.

Further, the target area marker is a second area marker; and a step of determining the display mode of the target area marker according to the height position information or the relative height information in the target position information, and displaying the first position marker of the target virtual object in the target area marker according to the display mode includes: if the height position information or the relative height information indicates that a height difference between the target virtual object and the first virtual object is zero, and a relationship between the target virtual object and the first virtual object is a hostile relationship, filling the target area marker with a first preset color that is highlighted at an outer edge and transparent to the interior; and if the height position information or the relative height information indicates that the height difference between the target virtual object and the first virtual object is not zero, and the relationship between the target virtual object and the first virtual object is the hostile relationship, filling the target area marker with the first preset color that is highlighted at an inner edge and transparent to the exterior.

Further, the target area marker is a third area marker; and a step of determining the display mode of the target area marker according to the height position information or the relative height information in the target position information, and displaying the first position marker of the target virtual object in the target area marker according to the display mode includes: if a relationship between the target virtual object and the first virtual object is a hostile relationship, filling the target area marker with a first preset color.

Further, the first preset color includes a plurality of different preset sub-colors, and the different preset sub-colors have different color depths, where the different preset sub-colors correspond to different distances between the first virtual object and the target virtual object within the range of target monitoring distances corresponding to the target area marker.

Further, a step of displaying the first position marker of the target virtual object in the target area marker includes: if a relationship between the target virtual object and the first virtual object is a non-hostile relationship, determining a target position matching the target position information from the target area marker, and displaying a first object marker of the target virtual object at the target position.

Further, the step of displaying the first object marker of the target virtual object at the target position includes: determining that the target virtual object is eliminated, and displaying a second object marker of the target virtual object at the target position.

Further, the method further includes: in response to the first virtual object being hit by a second virtual object in the game scene, obtaining orientation information and height information of the second virtual object in the game scene; and displaying a damage marker on the graphical user interface based on the orientation information and the height information, where the damage marker is used to indicate an orientation of the second virtual object, and the second virtual object is a virtual object that is in a hostile relationship with the first virtual object.

Further, a step of displaying the damage marker on the graphical user interface based on the orientation information and the height information includes: determining relative orientation information and relative height information of the second virtual object relative to the first virtual object according to the orientation information and the height information; determining a designated area marker that matches the relative orientation information from a plurality of area markers of the area monitoring marker according to the relative position information and the relative height information; and determining a display mode of the damage marker according to the relative height information, and displaying the damage marker in an external area corresponding to the designated area marker according to the display mode.

Further, the damage marker is a three-dimensional conical marker; and a step of determining the display mode of the damage marker according to the relative height information, and displaying the damage marker in the external area corresponding to the designated area marker according to the display mode includes: if the relative height information is zero, determining that the display mode of the damage marker is a first display mode, and displaying the damage marker in the external area corresponding to the designated area marker according to the first display mode, where the first display mode indicates that a height of the second virtual object relative to the first virtual object is zero; if the relative height information is greater than zero, determining that the display mode of the damage marker is a second display mode, and displaying the damage marker in the external area corresponding to the designated area marker according to the second display mode, where the second display mode indicates that the height of the second virtual object relative to the first virtual object is greater than zero; and if the relative height information is less than zero, determining that the display mode of the damage marker is a third display mode, and displaying the damage marker in the external area corresponding to the designated area marker according to the third display mode, where the third display mode indicates that the height of the second virtual object relative to the first virtual object is less than zero.

Further, the area markers include a plurality of second area markers and a plurality of third area markers, and the method further includes: in response to the first virtual object obtaining a designated virtual item, increasing numbers of the second area markers and the third area markers, or increasing the monitoring range parameter, where the number of the second area markers is the same as the number of the third area markers.

In a second aspect, an embodiment of the present disclosure further provides an apparatus for displaying position information. A graphical user interface is displayed by a terminal device, the graphical user interface includes a scene screen of a game scene and a first virtual object located in the game scene, and the first virtual object is a virtual object controlled by the terminal device. The apparatus includes: an area monitoring display module, configured to display an area monitoring marker on the graphical user interface, where a monitored area corresponding to the area monitoring marker is a spatial area of the game scene determined according to a current position of the virtual object and a monitoring range parameter, the area monitoring marker includes a plurality of area markers, and the area marker corresponds to a scene area within a range of target monitoring direction and a range of target monitoring distance in the game scene; a target position information obtaining module, configured to determine a target virtual object, and obtain target position information of the target virtual object in the game scene, where the target virtual object is a virtual object other than the first virtual object in the game scene; an area marker determination module, configured to determine a target area marker from the plurality of area markers according to the target position information, where a scene area within the range of target monitoring directions and the range of target monitoring distances corresponding to the target area marker matches the target position information; and an area marker display module, configured to determine a display mode of the target area marker according to height information in the target position information, and display the target area marker according to the display mode.

In a third aspect, an embodiment of the present disclosure provides an electronic device, including a processor and a memory. The memory stores computer-executable instructions that can be executed by the processor, and the processor executes the computer-executable instructions to implement the method for displaying position information according to any one of the first aspects.

In a fourth aspect, an embodiment of the present disclosure provides a computer-readable storage medium, which stores computer-executable instructions. When the computer-executable instructions are called and executed by a processor, the computer-executable instructions prompt the processor to implement the method for displaying position information according to any one of the first aspects.

The embodiments of the present disclosure bring the following beneficial effects.

The present disclosure provides a method and apparatus for displaying position information, and an electronic device, where an area monitoring marker is displayed on a graphical user interface, and the area monitoring marker includes a plurality of area markers. A target virtual object is determined, and target position information of the target virtual object in a game scene is obtained. A target area marker is determined from the plurality of area markers according to the target position information, a display mode of the target area marker is determined according to height information in the target position information, and the target area marker is displayed according to the display mode. In this method, the position information of a virtual object other than the first virtual object in the game scene is displayed through the target area marker in the plurality of area markers, the distance, orientation and height of the virtual object relative to the first virtual object can be accurately provided, which is conducive to the player making decisions in the game according to the distance and orientation of the virtual object, thereby improving the game experience of the player.

Other features and advantages of the present disclosure will be described in the following specification, and partially become apparent from the specification, or be understood by implementing the present disclosure. The purpose and other advantages of the present disclosure are realized and obtained by the structures particularly pointed out in the specification, claims and accompanying drawings.

In order to make the above-mentioned purposes, features and advantages of the present disclosure more obvious and easy to understand, preferred embodiments are specifically cited below and described in detail with reference to the accompanying drawings as follows.

### BRIEF DESCRIPTION OF THE DRAWINGS

FIG. 1 is a schematic diagram of a display of position information provided by an embodiment of the present disclosure;

FIG. 2 is a schematic diagram of another display of position information provided by an embodiment of the present disclosure;

FIG. 3 is a flow chart of a method for displaying position information provided by an embodiment of the present disclosure;

FIG. 4 is a schematic diagram of an area monitoring marker provided by an embodiment of the present disclosure;

FIG. 5 is a schematic diagram of another area monitoring marker provided by an embodiment of the present disclosure;

FIG. 6 is a schematic diagram of another area monitoring marker provided by an embodiment of the present disclosure;

FIG. 7 is a schematic diagram of another area monitoring marker provided by an embodiment of the present disclosure;

FIG. 8 is a schematic diagram of another area monitoring marker provided by an embodiment of the present disclosure;

FIG. 9 is a schematic diagram of another area monitoring marker provided by an embodiment of the present disclosure;

FIG. 10 is a schematic structural diagram of an apparatus for displaying position information provided by an embodiment of the present disclosure;

FIG. 11 is a schematic structural diagram of an electronic device provided by an embodiment of the present disclosure.

### DETAILED DESCRIPTION

In order to make the objects, technical solutions and advantages of the embodiments of the present disclosure clearer, the technical solutions in the present disclosure will be clearly and completely described in the following with reference to the accompanying drawings. Obviously, the described embodiments are a part of the embodiments of the present disclosure, and not all of the embodiments. Based on the embodiments in the present disclosure, all other embodiments obtained by a person of ordinary skill in the art without creative efforts fall within the scope of protection of the present disclosure.

The method for displaying position information in one of the embodiments of the present disclosure may be run on a local terminal device or a server. When the method for displaying position information is run on the server, the method for displaying position information may be implemented and executed based on a cloud interaction system, where the cloud interaction system includes a server and a client device.

In an optional implementation manner, various cloud applications, such as cloud games, may be run under the cloud interaction system. Taking cloud games as an example, cloud games refer to a game mode based on cloud computing. In the operation mode of cloud games, the operating body of the game program and the main body for presenting the game screen are separated. The storage and operation of the method for displaying the position information are completed on the cloud game server, and the client device is used for receiving and sending data as well as presenting the game screen. For example, the client device may be a display device close to the user side with a data transmission function, such as a mobile terminal, a TV, a computer, a handheld computer, etc., while the cloud game server in the cloud is used for information processing. When playing the game, the player operates the client device to send an operation instruction to the cloud game server, the cloud game server runs the game according to the operation instruction, encodes and compresses data like the game screen, and returns it to the client device through the network. Finally, the client device decodes and outputs the game screen.

In an optional implementation manner, taking a game as an example, a local terminal device stores a game program and is used for presenting a game screen. The local terminal device is used to interact with the player via a graphical user interface, that is, the game program is downloaded and installed by an electronic device and run conventionally. The local terminal device may provide the graphical user interface to the player in various ways, for example, the graphical user interface may be rendered and displayed on a display screen of the terminal, or provided to the player through a holographic projection. By way of example, the local terminal device may include a display screen and a processor, the display screen is used to present the graphical user interface, the graphical user interface includes a game screen, and the processor is used to run the game, generate the graphical user interface, and control the display of the graphical user interface on the display screen.

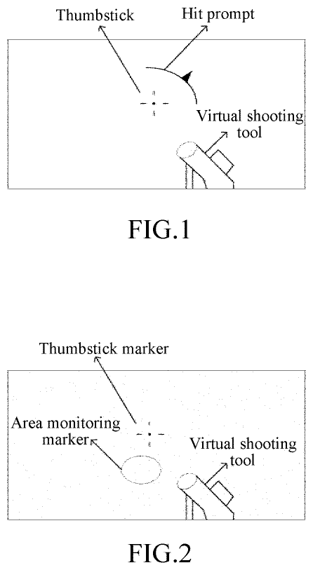

Currently, the hit prompts in existing shooting mobile games are all two-dimensional damage prompts around the thumbstick, and the main design is indicating the source of the hit by arrows. In the design scheme shown in FIG. 1, when an enemy target within a certain range nearby hits the player's virtual object, an arc-shaped red arrow prompt (the hit prompt as shown in FIG. 1) will appear around the thumbstick. The method of arrow indication identifies the current orientation of the target, helping the player to be able to roughly predict the position of the enemy to solve the tactical actions in next stage.

However, this prompt method has only one orientation, which cannot more accurately reveal the specific distance of the enemy, and cannot expose the specific spatial position of the enemy. It is not conducive to players making decisions in the game and affects the game experience of players. Based on this, the embodiments of the present disclosure provide a method and apparatus for displaying position information, and an electronic device, and the technology may be applied to mobile phones, tablet computers, laptops and other devices.

To facilitate understanding of the present embodiment, a method for displaying position information disclosed in an embodiment of the present disclosure is first introduced in detail. A graphical user interface is displayed by a terminal device, and the graphical user interface includes a scene screen of a game scene and a first virtual object located in the game scene. The first virtual object is a virtual object controlled by the terminal device. The terminal device may be the local terminal device mentioned above, or it may be the client device in the cloud interaction system mentioned above. In addition, when the first virtual object holds a virtual shooting tool, the above-mentioned graphical user interface typically further includes the virtual shooting tool located in the game scene. In this case, a thumbstick marker and an area monitoring marker corresponding to the virtual shooting tool are also displayed on the scene screen, where the thumbstick marker and the area monitoring marker have a specified display position relationship with the virtual shooting tool, respectively. At this time, the thumbstick marker is at the position shot or aimed at by the virtual shooting tool.

In addition, when the first virtual object does not hold any tool, the above-mentioned graphical user interface usually only includes the whole or part of the first virtual object. In this case, the scene screen may display only the area monitoring marker (the area monitoring marker has a specified display position relationship with the first virtual object), or display the thumbstick marker and the area monitoring marker (the area monitoring marker has a specified display position relationship with the thumbstick marker corresponding to the first virtual object), and at this time, the thumbstick marker is at the position aimed at by the first virtual object. The thumbstick marker corresponding to the first virtual object may not be displayed in the above-mentioned graphical user interface. The above-mentioned terminal device may be a touch-screen device such as a mobile phone or a tablet computer, or it may be a non-touch-screen device such as a computer or a laptop computer. The above-mentioned game scene usually refers to a game scene of a shooting game. The above-mentioned virtual shooting tool may be a virtual gun, a virtual bow and arrow, etc.

The above-mentioned scene screen usually includes the first virtual object controlled by the player and the virtual shooting tool controlled by the player. It may also include only the virtual shooting tool controlled by the player, or, it may also include only the first virtual object controlled by the player. The above-mentioned thumbstick marker may be a point, or it may be a marker of other shapes, such as the thumbstick markers shown in FIG. 1 and FIG. 2. In addition, exemplarily, as shown in FIG. 2, the above-mentioned thumbstick marker and the area monitoring marker have a specified display position relationship with the virtual shooting tool, respectively, and the thumbstick marker moves with the movement of the virtual shooting tool. Alternatively, when the first virtual object does not hold any tool, the thumbstick marker is a marker corresponding to the first virtual object, and the thumbstick marker moves with the movement of the first virtual object. The area monitoring marker is usually displayed at a position below the thumbstick mark, and will also move with the movement of the first virtual object. Alternatively, the thumbstick marker may not be displayed in the scene screen, in this case, the area monitoring marker will also move with the movement of the first virtual object.

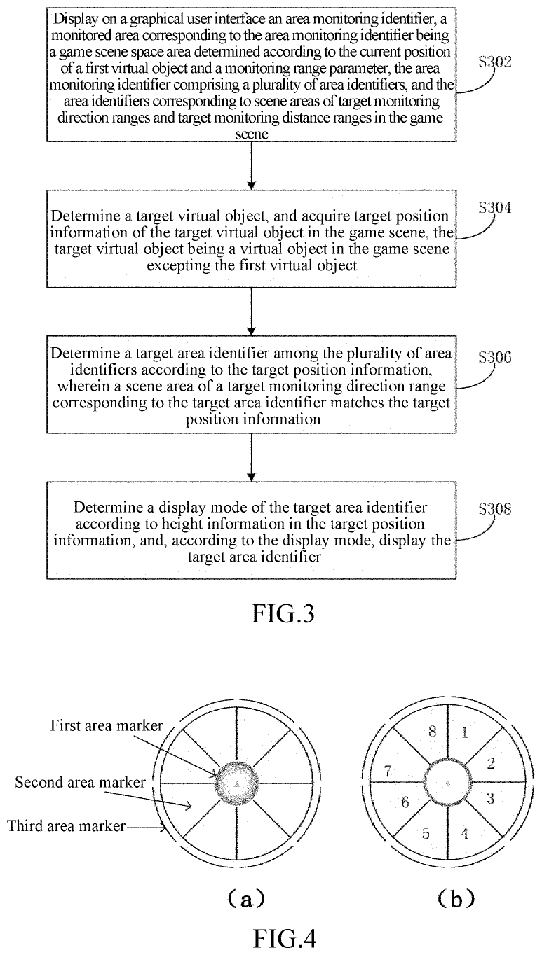

As shown in FIG. 3, the method includes the following steps.

In step S302, an area monitoring marker is displayed on the graphical user interface, where a monitored area corresponding to the area monitoring marker is a spatial area of the game scene determined according to a current position of the first virtual object and a monitoring range parameter, the area monitoring marker includes a plurality of area markers, and the area marker corresponds to a scene area within a range of target monitoring direction and a range of target monitoring distance in the game scene.

The center position of the above-mentioned area monitoring marker corresponds to the first virtual character, the above-mentioned monitoring range parameter may be a parameter such as a radius and a side length, etc., and the above-mentioned spatial area of the game scene may be a circular area, a square area, an elliptical area, etc. For example, the monitored area corresponding to the above-mentioned area monitoring marker may be a spatial area of the game scene with the current position of the first virtual object as the center of a circle and a specified distance as the radius, and the spatial area of the game scene corresponds to the area monitoring marker.

The above-mentioned area monitoring marker may be in the shape of a circle, a square, etc., and the above-mentioned area marker may also be a circular marker, a square marker, a sector marker, a line marker, etc. Different area markers correspond to different scene areas in the game scene within the range of target monitoring direction and the range of target monitoring distance. For example, an area marker located in the central area of the area monitoring marker corresponds to a scene area with a range of target monitoring distance being a radius of 10 meters with the first virtual object as the center of the circle. For another example, an area marker located in another designated area of the area monitoring marker corresponds to a scene area determined with taking the first virtual object as the reference, where the range of target monitoring direction is a range located at the northeast direction of the first virtual object and the range of target monitoring distance is a range of 10-20 meters. For another example, an area marker located at the edge area of the area monitoring marker corresponds to a scene area determined with taking the first virtual object as the reference, where the range of target monitoring direction is a range located at the southeast direction of the first virtual object and the range of target monitoring distance is a range of 20-30 meters.

In actual implementation, in response to that the first virtual object corresponding to the virtual shooting tool moves in the game scene, the scene screen is controlled to change. After the scene screen changes, the thumbstick marker and the area monitoring marker will be displaced relative to the scene screen. The above-mentioned first virtual object is a virtual object controlled by the player, that is, the virtual shooting tool is also a tool controlled by the player. The above-mentioned scene screen displays a screen of the game scene captured by a virtual camera corresponding to the first virtual object, and the virtual shooting tool is always displayed in the scene screen. The above-mentioned area monitoring marker usually has a specified shape, such as a circle, an ellipse, etc. In order not to affect the player's viewing of the scene screen, the area monitoring marker is usually displayed in a semi-transparent state to avoid interference with the search for the enemy via the thumbstick.

Specifically, the player may control the mobile control displayed on the graphical user interface to control the first virtual object to move in the game scene, or control the external input device (such as a mouse, keyboard, etc.) to control the first virtual object to move in the game scene, thereby causing the scene screen displayed on the graphical user interface to change according to the movement of the first virtual object, that is, the virtual camera corresponding to the first virtual object is controlled to move, thereby causing the captured scene screen to change. At the same time, the virtual shooting tool displayed on the scene screen may move along with the first virtual object, and similarly, the thumbstick marker and the area monitoring marker may also move relatively along with the virtual shooting tool in the scene screen.

In step S304, a target virtual object is determined, and target position information of the target virtual object in the game scene is obtained, where the target virtual object is a virtual object other than the first virtual object in the game scene.

In the game scene, all virtual objects other than the first virtual object are monitored, and specifically, the position information of all virtual objects other than the first virtual object is monitored. When the virtual object is located in the monitored area corresponding to the area monitoring marker (i.e., the spatial area of the game scene), the virtual object may be determined as the above-mentioned target virtual object. It is also possible to specifically monitor the virtual object(s) with a specified state other than the first virtual object. When the virtual object(s) with the specified state is located in the monitored area corresponding to the area monitoring marker (i.e., the spatial area of the game scene), the virtual object is determined as the above-mentioned target virtual object. The specified state may be shooting, releasing skills, etc.

After determining the target virtual object, the target position information of the target virtual object in the game scene is obtained. The target position information is usually position coordinates of the target virtual object in a three-dimensional coordinate system corresponding to the game scene, where the origin of the three-dimensional coordinate system corresponding to the game scene may be any position in the game scene. The above target position information may also be the position coordinates of the target virtual object relative to the first virtual object, that is, the position coordinates in a corresponding three-dimensional coordinate system with the position of the first virtual object as the origin. The above target position information usually reflects distance information, orientation information, height information, etc.

The target virtual object may be a virtual object in a hostile relationship with the first virtual object, such as an enemy virtual character, a virtual vehicle controlled by the enemy virtual character, etc. It may also be a virtual object in a non-hostile relationship with the first virtual object, such as a teammate virtual character, a virtual vehicle controlled by the teammate virtual character, etc.

In step S306, a target area marker is determined from the plurality of area markers according to the target position information, where a scene area within the range of target monitoring direction and the range of target monitoring distance corresponding to the target area marker matches the target position information.

Specifically, it is necessary to determine a target area marker that matches the target position information from a plurality of area markers according to the target position information. The distance, orientation, height, etc., of the target virtual object relative to the first virtual object may be determined according to the target position information, and the target area marker that matches the distance and orientation may be determined from the plurality of area markers according to the distance and orientation. The target area marker may represent the distance and orientation of the target virtual object relative to the first virtual object. In other words, the position indicated by the target position information of the target virtual object is located in the scene area within the range of target monitoring direction and the range of target monitoring distance corresponding to the target area marker.

In step S308, a display mode of the target area marker is determined according to height information in the target position information, and the target area marker is displayed according to the display mode.

The above display modes usually include a variety of display forms, where different display modes are mainly determined according to the height information. For example, if the height information is zero, the target area marker is displayed in a preset first display form. For example, if the height information is not zero, the target area marker is displayed in a preset second display form. In addition, the target area marker may have different shapes, and the specific display modes of area marks with different shapes are also different. Secondly, the display mode may also display different information according to the relationship between the target virtual object and the first virtual object.

It should be noted that the target area marker is used to indicate the distance and orientation of the target virtual object relative to the first virtual object, and the display mode of the target area marker is used to indicate the vertical distance, i.e., the height distance, of the target virtual object relative to the first virtual object.

The above method for displaying position information displays an area monitoring marker on the graphical user interface, and the area monitoring marker includes a plurality of area markers. A target virtual object is determined, and target position information of the target virtual object in a game scene is obtained. A target area marker is determined from the plurality of area markers according to the target position information, a display mode of the target area marker is determined according to height information in the target position information, and the target area marker is displayed according to the display mode. In this method, the position information of a virtual object other than the first virtual object in the game scene is displayed through the target area marker of the plurality of area markers, and the distance, orientation and height between the virtual object and the first virtual object can be accurately provided, which is conducive to the player making decisions in the game according to the distance and orientation of the virtual object, thereby improving the game experience of the player.

In the above step S304, a possible implementation manner of the step of determining the target virtual object is as follows.

A candidate virtual object that performs a preset game behavior is determined, and orientation information of the candidate virtual object is obtained; and if the orientation information of the candidate virtual object is within the monitored area, the candidate virtual object is determined as the target virtual object.

The preset game behavior may be a skill release behavior, a shooting behavior, an attack behavior, etc. The above candidate virtual object may be a virtual object in a hostile relationship with the first virtual object, or a virtual object in a non-hostile relationship with the first virtual object. The above orientation information (position information) may be absolute orientation information of the candidate virtual object relative to the game scene, or relative orientation information of the candidate virtual object relative to the first virtual object. The orientation information is usually coordinate information. By way of example, when a virtual object in a game scene is performing a preset game behavior, the virtual object is determined as a candidate virtual object, and then the orientation information of the candidate virtual object is obtained. According to the orientation information, it is determined whether the candidate virtual object is located in the monitored area corresponding to the area monitoring marker. If the candidate virtual object is in the spatial area of the game scene corresponding to the monitored area, the candidate virtual object is determined to be a target virtual object. In this way, the game behaviors of virtual object(s) other than the first virtual object in the game scene are monitored, and only when the virtual object that performs the preset game behavior is in the monitored area, the virtual object may be determined as the target virtual object, which further improves the game experience of the player.

In addition, the above target position information is absolute position information of the target virtual object relative to the game scene, and the absolute position information includes at least one of following information: horizontal position information and height position information; or, the target position information is relative position information of the target virtual object relative to the first virtual object, and the relative position information includes at least one of following information: relative distance information, relative orientation information and relative height information.

The above absolute position information and the relative position information are both the coordinates of the target virtual object in a three-dimensional coordinate system, where the three-dimensional coordinate system may be a three-dimensional coordinate system with any position in the game scene as the origin, or a three-dimensional coordinate system with the first virtual object as the origin. Among them, the target position information of the target virtual object obtained from the three-dimensional coordinate system with any position in the game scene as the origin is the absolute position information, and the target position information of the target virtual object obtained from the three-dimensional coordinate system with the first virtual object as the origin is the relative position information.

The above horizontal position information is usually determined via a two-dimensional coordinate system, and the above height position information is usually determined via a three-dimensional coordinate system. The above relative distance information is usually used to indicate the distance between the target virtual object and the first virtual object, the above relative orientation information is usually used to indicate the direction of the target virtual object relative to the first virtual object, and the above relative height information is usually used to indicate the height difference between the target virtual object and the first virtual object.

The distance, orientation and height difference between the target virtual object and the first virtual object can be calculated according to either the absolute position information or the relative position information. The distance refers to the horizontal distance between the target virtual object and the first virtual object in the game scene, the orientation refers to the direction of the target virtual object relative to the first virtual object in the game scene, and the height refers to the vertical distance between the target virtual object and the first virtual object in the game scene.

In the above step S306, a possible implementation manner of the step of determining the target area marker from the plurality of area markers according to the target position is as follows.

The target area marker is determined from the plurality of area markers according to the horizontal position information, or the relative distance information and the relative orientation information in the target position information.

The above different area markers are used to indicate different distances and orientations between the target virtual object and the first virtual object. For example, first candidate area markers of the area monitoring marker indicate that the distance between the target virtual object and the first virtual object is relatively close, and edge area markers of the area monitoring marker indicate that the distance between the target virtual object and the first virtual object is relatively far. For another example, area markers on the right side relative to the first virtual object in the area monitoring marker indicate that the orientation of the target virtual object relative to the first virtual object is on the right.

In actual implementation, the relative distance information and relative orientation information may be determined according to the horizontal position information, so the target area marker that matches the relative distance information and relative orientation information may be determined from the plurality of area markers according to the horizontal position information or directly according to the relative distance information and the relative orientation information. For example, if the range of target monitoring directions corresponding to the area marker \textcircled{1} in the plurality of area markers is southeast direction, the range of target monitoring distances corresponding to the area marker \textcircled{1} in the plurality of area markers is 10-20 meters, the relative distance information is 15 meters, and the relative orientation information is southeast direction, then the area marker \textcircled{1} may be determined as the target area marker.

Since the above plurality of area markers include a first area marker, a plurality of second area markers and a plurality of third area markers, as shown in FIG. 4, a possible implementation manner of the above step of determining the target area marker from the plurality of area markers according to the horizontal position information, or the relative distance information and the relative orientation information in the target position information is as follows.

If the horizontal position information or the relative distance information indicates that the horizontal distance between the target virtual object and the first virtual object is less than or equal to a first preset distance, the first area marker is determined as the target area marker.

In the above plurality of area markers, each area marker is used to indicate a different distance and a different orientation between the target virtual object and the first virtual object. At the same time, the display form of the area marker is pre-set, and the relationship between the target virtual object and the first virtual object, as well as the spatial position of the target virtual object and the first virtual object are indicated through different display forms.

In actual implementation, the terminal device may obtain the target position information of virtual objects other than the first virtual object in the game scene in real time, which includes the horizontal position information or relative distance information and relative orientation information, where the relative distance information and relative orientation information may be determined according to the horizontal position information. Therefore, when the relative distance information is less than or equal to the first preset distance, the first area marker may be determined as the target area marker. The above range less than the first preset distance may be understood as the range of target monitoring distance corresponding to the first area marker.

The above first preset distance may be set according to the actual game scene, for example, 5 meters, etc. The above first area marker may be a circle as shown in FIG. 4, or other shapes, such as an ellipse, a square, a polygon, etc.

As shown in FIG. 4, the above plurality of area markers include a plurality of second area markers, and each second area marker has a different relative direction to a center point of the first area marker. Another possible implementation manner of the step of determining the target area marker from the plurality of area markers according to the horizontal position information, or the relative distance information and the relative orientation information in the target position information is as follows.

If the horizontal position information or the relative distance information indicates that the horizontal distance between the target virtual object and the first virtual object is greater than the first preset distance and less than or equal to a second preset distance, the second area markers are determined as first candidate area markers; and if the horizontal position information or the relative orientation information indicates that the orientation of the target virtual object relative to the first virtual object is a first direction, the target area marker that matches the first direction is determined from the first candidate area markers.

The above range which is greater than the first preset distance and less than or equal to the second preset distance may be understood as the range of target monitoring distances corresponding to the second area marker, and the above different directions may be understood as the range of target monitoring directions corresponding to different second area markers.

The above second preset distance may be set according to the actual game scene, for example, 15 meters, etc. The number of the above second area markers may be one or more than one, if there is one second area marker, the above second area marker may be the circular ring area outside the first area marker shown in FIG. 4, and if there are more than one second area markers, the second area markers may be the sector areas shown in FIG. 4 (i.e., sectors 1-8, 8 areas in the figure). The second area markers may also be other shapes, such as triangles, quadrilaterals, etc. Specifically, when the distance between the target virtual object and the first virtual object is greater than the first preset distance and less than or equal to the second preset distance, the second area markers are determined as the first candidate area markers.

Since there are a plurality of the above-mentioned second area markers, after determining the distance between the target virtual object and the first virtual object, it is unable to determine which area marker among the plurality of second area markers is the target area marker. Therefore, the first direction of the target virtual object relative to the first virtual object may be determined, and the target area marker that matches the first direction may be determined from the plurality of second area markers, where the first direction is a direction in the horizontal orientation.

By way of example, the first direction of the target virtual object relative to the first virtual object is that the target virtual object is located in front of the right side of the first virtual object, then a target area marker located in front of the right side of a reference position marker (i.e., the center of the first area marker) is determined from the plurality of second area markers, such as sector 1 in FIG. 4, as the target area marker.

In the above manner, the target area marker is determined by the distance and orientation between the target virtual object and the first virtual object. The distance between the virtual objects is represented by the target area marker, so that the distance and orientation of the target virtual object can be accurately determined.

The above plurality of area markers include a plurality of third area markers, and each third area marker has a different relative direction to the center point of the first area marker. A possible implementation manner of the step of determining the target area marker from the plurality of area markers according to the horizontal position information, or the relative distance information and the relative orientation information in the target position information is as follows.

If the horizontal position information or the relative distance information indicates that the horizontal distance between the target virtual object and the first virtual object is greater than the second preset distance and less than or equal to a third preset distance, the third area markers are determined as second candidate area markers; and if the horizontal position information or the relative orientation information indicates that the orientation of the target virtual object relative to the first virtual object is a second direction, the target area marker that matches the second direction is determined from the second candidate area markers.

The above third preset distance may be set according to the actual needs of the game, for example, 25 meters, etc. The above third area marker may be a circular line or an arc line. When there is one third area marker, the third area marker may be a circular line. When there is more than one third area marker, the third area markers may be arc lines. Specifically, when the distance between the target virtual object and the first virtual object is greater than the second preset distance and less than or equal to the third preset distance, the third area markers are determined as the second candidate area markers.

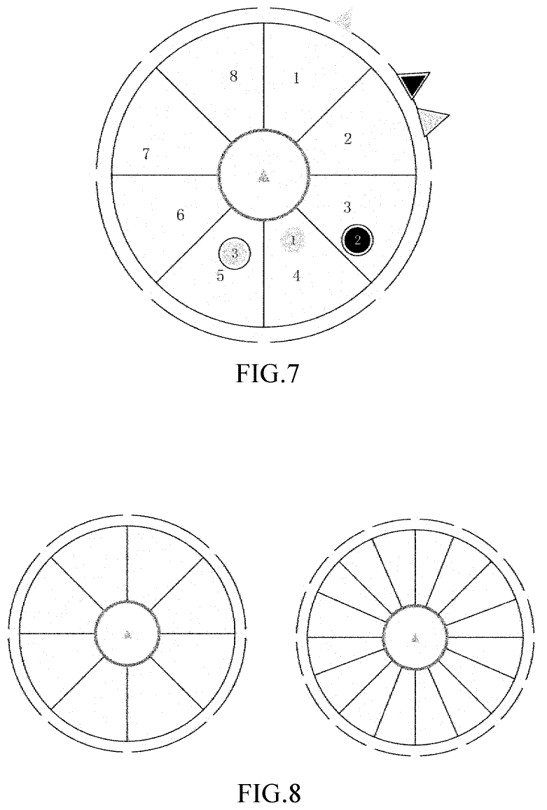

As shown in FIG. 6, there are a plurality of the third area markers, each third area marker has a different relative direction to the center of the first area marker, and each third area marker corresponds to a second area marker. For example, the area monitoring marker in FIG. 6 includes 8 third area markers, each of which represents a relative direction. The above third area markers may include 2, 3 or even more, which may be set according to the actual requirements of the game.

Since there are a plurality of the above-mentioned third area markers, after determining the distance between the target virtual object and the first virtual object, it is unable to determine which area marker among the plurality of third area markers is the target area marker. Therefore, the second direction of the target virtual object relative to the first virtual object may be determined, and the target area marker that matches the second direction may be determined from the plurality of third area markers, where the second direction is a direction in the horizontal orientation.

By way of example, the second direction of the target virtual object relative to the first virtual object is that the target virtual object is located in front of the right side of the first virtual object, then a third area marker located in front of the right side of the reference position marker (the center of the first area marker) is determined from the plurality of third area markers as the target area marker, such as the lines corresponding to the outside of sectors 1 and 2 in FIG. 6, which are the target area markers.

In the above manner, the target area marker is determined by the distance and direction of the target virtual object relative to the first virtual object. The distance between the virtual objects is represented by the target area marker, so that the distance and orientation of the target virtual object can be accurately determined.

Further, as shown in FIG. 4, the above area monitoring marker is a first circle, the first area marker of the plurality of area markers is a second circle, a radius of the first circle is greater than a radius of the second circle, and a center of the first circle is at a same position as a center of the second circle. The second area markers of the plurality of area markers are sectors divided from a circular ring between the first circle and the second circle; and third area markers of the plurality of area markers are outer lines of the first circle.

In addition, the above area monitoring marker is provided with a reference position marker, as shown in FIG. 4, which is a triangle at the center of the area monitoring marker, and the reference position marker corresponds to the first virtual object. That is, the reference position marker displayed by the area monitoring marker is the position of the first virtual object in the area monitoring marker. It should be noted that the area monitoring marker shown in FIG. 4 as a circle and the reference position marker as a triangle are only examples, and they may also be other shapes.

The following describes a possible implementation of the step of determining the display mode of the target area marker according to the height information in the target position information, and displaying the target area marker according to the display mode.

The display mode of the target area marker is determined according to the height position information or the relative height information in the target position information, and a first position marker of the target virtual object is displayed in the target area marker according to the display mode, where the first position marker is used to indicate the target position information of the target virtual object relative to the first virtual object, and a relative position of the first position marker to the reference position marker matches a relative position of the target virtual object to the first virtual object.

Specifically, the relative position between the virtual objects may be represented by the relative position between the first position marker and the reference position marker. Each position in the above-mentioned area monitoring marker corresponds to a different distance and different orientation between the target virtual object and the first virtual object. That is, the relative position between the above-mentioned first position marker and the reference position marker matches the relative position between the target virtual object and the first virtual object.

In actual implementation, the distance and orientation between the target virtual object and the first virtual object may be obtained in real time, and then the target area marker for displaying the first position marker is determined in the area monitoring marker according to the distance and orientation, that is, the relative position of the above target virtual object to the first virtual object, and the first position marker is displayed in the target area marker. In this case, the relative position between the first position marker and the reference position marker matches the above relative position of the target virtual object to the first virtual object. In other words, the relative position of the target virtual object to the first virtual object is that the distance between the target virtual object and the first virtual object is 10 meters, and the orientation is to the right. The relative position of the first position marker to the reference position marker is that the distance between the first position marker and the reference position marker is 2 centimeters, and the orientation is to the right. The distance of 2 centimeters in the area monitoring marker matches 10 meters in the game scene.

In addition, the first position marker usually includes markers in a variety of display forms, and markers in different display forms are used to indicate different virtual objects and different control positions.

In the above manner, the first position marker and the reference position marker are displayed in the area monitoring marker, and the relative positions between the virtual objects are represented by the relative positions between the markers, so that the position of the target virtual object can be accurately determined.

The above area monitoring marker includes a first area marker and second area markers, the middle circular area shown in FIG. 4 is the first area marker, the surrounding sector areas are the second area markers, and the reference position marker is located at the first area marker. If the above target area is the first area marker, a possible implementation manner of the step of determining the display mode of the target area marker according to the height position information or the relative height information in the target position information, and displaying the first position marker of the target virtual object in the target area marker according to the display mode is as follows.

(1) If the height position information or the relative height information indicates that the height difference between the target virtual object and the first virtual object is zero, and the relationship between the target virtual object and the first virtual object is a hostile relationship, the target area marker is filled with a first preset color that is highlighted at the edge and transparent to the interior.

The above first area marker may be a circle as shown in FIG. 4, or other shapes, such as an ellipse, a square, a polygon, etc. The first position mark displayed in the first area marker may be a circular pattern with a specified color, or a circular line with a specified color, or a circular pattern with a specified color and lines of other colors on the outside. Different first position markers usually indicate different virtual objects.

Specifically, when the distance between the target virtual object and the first virtual object is less than or equal to the first preset distance, the first position marker is displayed in the first area marker. In this case, the player may determine the distance between the target virtual object and the first virtual object according to the first position marker displayed at the first area marker, and may also determine a spatial position between the target virtual object and the first virtual object.

If the relationship between the target virtual object and the first virtual object is a hostile relationship, and the height position information or the relative height information indicates that the height difference between the target virtual object and the first virtual object is zero, it is determined that the spatial orientation of the target virtual object relative to the first virtual object is a horizontal orientation, and the first area marker is filled with a first preset color that is highlighted at the edge and gradually becomes transparent toward the inside.

The above horizontal orientation means that there is no height difference between the target virtual object and the first virtual object. The above first preset color may be yellow, red, green, etc., and may be set according to actual needs. As shown in (a) of FIG. 4, when the spatial orientation of the first virtual object relative to the first virtual object is the horizontal orientation, the first area marker is filled with the first preset color that is highlighted at the edge and gradually becomes transparent toward the inside.

(2) If the height position information or the relative height information indicates that the height difference between the target virtual object and the first virtual object is not zero, and the relationship between the target virtual object and the first virtual object is a hostile relationship, a line with a first preset color is displayed at the edge of the target area marker.

If the height position information or the relative height information indicates that the height difference between the target virtual object and the first virtual object is not zero, it is determined that the spatial orientation of the target virtual object relative to the first virtual object is a vertical orientation, and the relationship between the target virtual object and the first virtual object is a hostile relationship, then a line with the first preset color is displayed on the edge of the first area marker, where the darker the first preset color is, the closer the target virtual object is to the first virtual object within the range of the first preset distance.

The vertical orientation means that there is a height difference between the target virtual object and the first virtual object, and the target virtual object may be located above the first virtual object or below the first virtual object. The above first preset color may be yellow, red, green, etc., and may be set according to actual needs. As shown in (b) of FIG. 4, when the spatial orientation of the target virtual object relative to the first virtual object is a vertical orientation, the first area marker is filled with the first preset color that is highlighted at the edge and gradually becomes transparent toward the inside.

In addition, the above first position marker may be displayed in a flashing manner to more clearly remind the player that there is an enemy virtual object nearby.

In the above manner, the spatial orientation between the virtual objects is represented by filling color or displaying lines in the first area marker, which facilitates accurately determining the relative position of the first virtual object and help the player make game decisions.

The above target area marker is a second area marker, and a possible implementation manner of the step of determining the display mode of the target area marker according to the height position information or the relative height information in the target position information, and displaying the first position marker of the target virtual object in the target area marker according to the display mode is as follows.

(1) If the height position information or the relative height information indicates that the height difference between the target virtual object and the first virtual object is zero, and the relationship between the target virtual object and the first virtual object is a hostile relationship, the target area marker is filled with a first preset color that is highlighted at the outer edge and transparent to the interior.

(2) If the height position information or the relative height information indicates that the height difference between the target virtual object and the first virtual object is not zero, and the relationship between the target virtual object and the first virtual object is a hostile relationship, the target area marker is filled with a first preset color that is highlighted at the inner edge and transparent to the exterior.

The first position marker displayed in the second area marker may be a pattern with a specified color and the same shape as the second area marker, or a circular pattern with a specified color, or a circular pattern with a specified color and a line of another color outside. Different first position markers usually indicate different virtual objects.

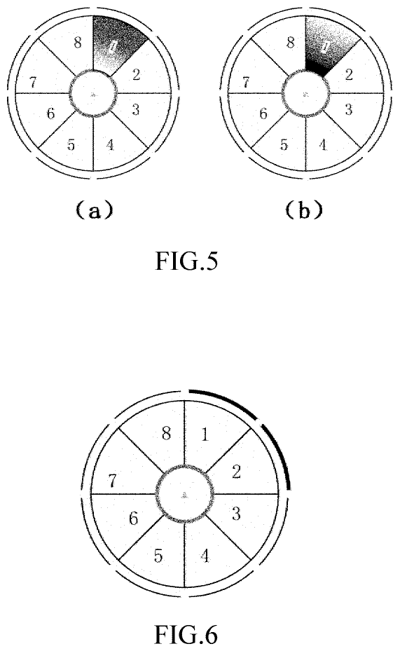

Similarly, the above first preset color may be set according to actual requirements. As shown in (a) of FIG. 5, if the height position information or the relative height information indicates that the height difference between the target virtual object and the first virtual object is zero, the spatial orientation of the target virtual object relative to the first virtual object is the horizontal orientation, and the target area marker (i.e., the second area marker) is filled with the first preset color that is highlighted at the outer edge and gradually becomes transparent toward the inside. As shown in (b) of FIG. 5, if the height position information or the relative height information indicates that the height difference between the target virtual object and the first virtual object is not zero, the spatial orientation of the target virtual object relative to the first virtual object is the vertical orientation, the target area marker is filled with the first preset color that is highlighted at the inner edge and gradually becomes transparent to the outside, where the darker the first preset color is, the closer the target virtual object is to the first virtual object within the range between the second preset distance and the first preset distance.

In the above manner, the spatial orientation between the virtual objects is represented by filling the second area marker with the first preset color in different gradient modes, which is conducive to accurately determining the relative position of the target virtual object and helping the player make game decisions.

In addition, as shown in FIG. 6, the above area monitoring marker further includes third area markers, and the third area markers are located on the outside of the area monitoring marker, that is, the outer lines of the circular area.

The above target area marker is the third area marker, and a possible implementation manner of the step of determining the display mode of the target area marker according to the height information in the target position information, and displaying the first position marker of the target virtual object in the target area marker according to the display mode is: if the relationship between the target virtual object and the first virtual object is a hostile relationship, the target area marker is filled with the first preset color.

The first position marker displayed at the above third area marker may be a line with a specified color or other patterns with a specified color. Different shapes usually indicate different relationships between the first virtual object and the target virtual object. Specifically, the first position marker is displayed at the target area marker, and the player may determine the distance between the target virtual object and the first virtual object according to the first position marker displayed at the third area marker, and may also determine the spatial position between the target virtual object and the first virtual object.

As shown in FIG. 6, there are a plurality of the above third area markers, and each third area marker has a different relative direction to the reference position marker. Each third area marker corresponds to a second area marker. For example, the area monitoring marker in FIG. 6 includes 8 third area markers, each of which represents one relative direction. There may be 2, 3 or even more above third area markers, which may be set according to the actual requirements of the game.

The above area monitoring marker is a circle, and the third area marker is the outer line of the circle. If the relationship between the target virtual object and the first virtual object is a hostile relationship, the outer line with the first preset color is displayed at the target third area marker, where the darker the first preset color is, the closer the target virtual object is to the first virtual object within the range of third preset distance.

Similarly, the above first preset color may be set according to actual requirements. As shown in FIG. 6, when the spatial orientation of the target virtual object relative to the first virtual object is the horizontal orientation, an outer line with the first preset color is displayed at the target third area marker. The darker the first preset color, the closer the target virtual object is to the first virtual object within the range between the second preset distance and the third preset distance.

In the above manner, the direction between the virtual objects is represented by displaying an outer line with the first preset color at the target third area marker, which is conducive to accurately determining the relative position of the target virtual object and helping the player make game decisions.

In addition, the first preset color includes a plurality of different preset sub-colors, and different preset sub-colors have different color depths, where different preset sub-colors correspond to different distances between the target virtual object and the first virtual object within the range of target monitoring distances corresponding to the target area marker. In other words, the darker the first preset color is, the closer the target virtual object is to the first virtual object within the range of target monitoring distances corresponding to the target area marker.

Furthermore, a possible implementation of the above step of displaying the first position marker of the target virtual object in the target area marker is as follows.

If the relationship between the target virtual object and the first virtual object is a non-hostile relationship, a target position that matches the target position information is determined from the target area marker; and the first object marker of the target virtual object is displayed at the target position.

Specifically, the relative position of the target virtual object to the first virtual object is determined according to the target position information, the target position that matches the relative position is determined from the target area marker, and the first object marker of the target virtual object is displayed at the target position.

If the target area markers are the first area marker and the second area marker, the first object markers of the target virtual objects may be directly displayed at the target positions. If the target area marker is the third area marker, the first object marker of the target virtual object may be directly displayed at the edge position of the third area marker. The first object marker of the target virtual object displayed at the edge of the third area marker is usually different from the first object marker of the target virtual object displayed at the target position.

As shown in FIG. 7, when the distance between the target virtual object and the first virtual object is less than or equal to the second preset distance, the target position that matches the distance is determined from the target area marker according to the specific distance and direction of the target virtual object relative to the first virtual object, and the target position matches the relative position between the target virtual object and the first virtual object. Then the first object marker of the target virtual object is displayed at the target position. There are a plurality of the first object markers, for example, when the target virtual object is a virtual character, a circular pattern filled with blue is displayed, which corresponds to \textcircled{1} in FIG. 7 (blue is represented by gray in FIG. 7). For another example, when the target virtual object is a virtual vehicle, a circular pattern filled with white is displayed, and the outer edge of the circular pattern includes a white circular line, which corresponds to \textcircled{2} in FIG. 7 (white is represented by black in FIG. 7). For another example, when the target virtual object is a virtual object driving a virtual vehicle, a circular pattern filled with blue is displayed, and the outer edge of the circular pattern includes a white circular line, which corresponds to \textcircled{3} in FIG. 7.

In addition, when the distance between the target virtual object and the first virtual object is greater than the second preset distance and less than the third preset distance, a target edge position that matches the distance is determined from the edge area of the area monitoring marker according to the specific distance and direction of the target virtual object relative to the first virtual object, and then the second object marker of the target virtual object is displayed at the target edge position. The second object mark is a pattern of a preset shape. For example, when the target virtual object is a virtual character, a triangular pattern filled with blue is displayed, which corresponds to the gray triangle located at the outer edge in FIG. 7. For another example, when the target virtual object is a virtual vehicle, a triangular pattern filled with white is displayed, and the outer edge of the triangular pattern includes a white circular line, which corresponds to the black triangle located at the outer edge in FIG. 7. For another example, when the target virtual object is a virtual object driving a virtual vehicle, a triangular pattern filled with blue is displayed, and the outer edge of the circular pattern includes a white circular line, which corresponds to the gray triangle with a black line on the edge located at the outer edge in FIG. 7.

In the above manner, the object markers of the virtual objects of teammates are displayed in the target area markers, it can not only accurately determine the positions of the enemy virtual objects, but also determine the positions between teammates, thereby further improving the efficiency of making game decisions by the player and improving the gaming experience of the user.

A possible implementation of the above step of displaying the first object marker of the target virtual object at the target position is as follows: determining that the target virtual object is eliminated, and displaying a second object marker of the target virtual object at the target position.

When the target virtual object is eliminated, the second object marker of the target virtual object is displayed at the target position, and the second object marker may be set according to actual needs, such as “×” in FIG. 7. In this manner, by displaying the second object marker of the target virtual object at the target position, it is indicated that the target virtual object is eliminated.

The above area monitoring marker includes a plurality of second area markers and a plurality of third area markers, and the above method further includes: in response to the first virtual object obtaining a specified virtual item, increasing the number of second area markers and the number of third area markers in the area monitoring marker, or increasing the monitoring range parameter, where the number of second area markers is the same as the number of third area markers.

When the first virtual object moves in the game scene, it usually acquires some game items. If a specified virtual item is acquired, the number of the second area markers and the third area markers in the area monitoring marker may be increased according to the number indicated by the specified virtual item. As shown in FIG. 8, the original 8 sector prompts are expanded to 12 grids, and the range for searching enemy is more accurate. At the same time, the direction that may be indicated by an external damage marker corresponding to each third area marker will also be increased. In addition, the monitoring range parameter of the monitored area may also be increased. For example, in the initial state, only the scene area with the first virtual object as the center and a radius of 30 meters may be monitored. After acquiring some game items, the scene area with the first virtual object as the center and a radius of 50 meters may be monitored. In this way, by setting the specified virtual items, the number of area markers and the monitoring range parameter may be increased, thereby further improving the efficiency of searching the enemy by the player.

In addition, it should be noted that in the actual game scene, the circular area monitoring marker may be displayed below the thumbstick marker, and needs to be tilted at a certain viewing angle, for example, 15 degrees upward, and it can be ensured that the prompts in each radar partition can be clearly identified as shown in FIG. 2.

The above manner solves the problem of broad hit prompts in the current shooting mobile games, and may help players determine the specific range where the enemy is hiding and predict the position of the virtual object in advance more accurately.

Furthermore, the above method further includes: in response to the first virtual object being hit by a second virtual object in the game scene, obtaining the orientation information and height information of the second virtual object in the game scene, and displaying a damage marker based on the orientation information and the height information, where the damage marker is used to indicate the orientation of the second virtual object, and the second virtual object is a virtual object that is in a hostile relationship with the first virtual object.

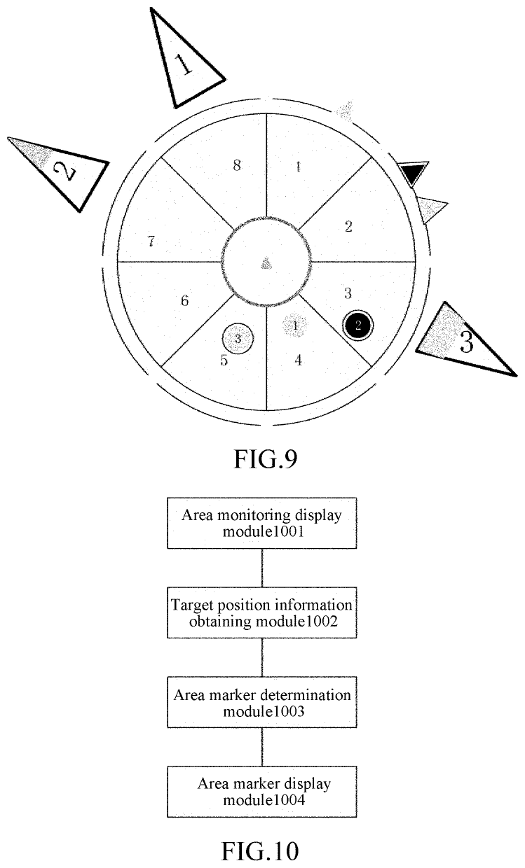

As shown in FIG. 9, damage markers are displayed on the graphical user interface. The above displayed damage markers are usually three-dimensional markers, such as triangular pyramids, etc.

A possible implementation of the above step of displaying the damage marker on the graphical user interface based on the orientation information and the height information is as follows: determining relative orientation information and relative height information of the second virtual object relative to the first virtual object according to the orientation information and the height information; determining a designated area marker that matches the relative orientation information from the plurality of area markers of the area monitoring marker according to the relative orientation information and the relative height information; determining a display mode of the damage marker according to the relative height information, and displaying the damage marker in an external area corresponding to the designated area marker according to the display mode.

The above damage marker is a three-dimensional conical marker, and a possible implementation manner of the step of determining the display mode of the damage marker according to the relative height information, and displaying the damage marker in the external area corresponding to the designated area marker according to the display mode is as follows.

(1) If the relative height information is zero, it is determined that the display mode of the damage marker is a first display mode, and the damage marker is displayed in the external area corresponding to the designated area marker according to the first display mode, where the first display mode indicates that a height of the second virtual object relative to the first virtual object is zero.

(2) If the relative height information is greater than zero, it is determined that the display mode of the damage marker is a second display mode, and the damage marker is displayed in the external area corresponding to the designated area marker according to the second display mode, where the second display mode indicates that a height of the second virtual object relative to the first virtual object is greater than zero.

(3) If the relative height information is less than zero, it is determined that the display mode of the damage marker is a third display mode, and the damage marker is displayed in the external area corresponding to the designated area marker according to the third display mode, where the third display mode indicates that a height of the third virtual object relative to the first virtual object is less than zero.

Exemplarily, for the damage marker 1 as shown in FIG. 9, the height of the second virtual object relative to the first virtual object is determined by the area filled with color in the damage marker, and if no color is filled, it indicates that the height of the second virtual object relative to the first virtual object is zero. The direction that may be indicated by the damage marker is the same as the direction that may be indicated by the second area marker. For the damage marker 2 as shown in FIG. 9, it is determined that the height of the second virtual object relative to the first virtual object is greater than zero through the area filled with color in the arrow area of the damage marker, and the more colors filled in, the greater the height value of the second virtual object relative to the first virtual object is, which is greater than zero. For the damage marker 3 as shown in the in FIG. 9, it is determined that the height of the second virtual object relative to the first virtual object is less than zero through the area filled with color in the non-arrow area of the damage marker, and the more colors filled in, the greater the height value of the second virtual object relative to the first virtual object is, which is less than zero.

Corresponding to the above method embodiments, an embodiment of the present disclosure provides an apparatus for displaying position information, where a graphical user interface is displayed by a terminal device, the graphical user interface includes a scene screen of a game scene and a first virtual object located in the game scene, the first virtual object is a virtual object controlled by the terminal device. As shown in FIG. 10, the apparatus includes:
an area monitoring display module 1001, configured to display an area monitoring marker on the graphical user interface, where a monitored area corresponding to the area monitoring marker is a spatial area of the game scene determined according to a current position of the first virtual object and a monitoring range parameter, the area monitoring marker includes a plurality of area markers, and the area marker corresponds to a scene area within a range of target monitoring direction and a range of target monitoring distance in the game scene;
a target position information obtaining module 1002, configured to determine a target virtual object, and obtain target position information of the target virtual object in the game scene, where the target virtual object is a virtual object other than the first virtual object in the game scene;
an area marker determination module 1003, configured to determine a target area marker from the plurality of area markers according to the target position information, where a scene area within the range of target monitoring directions and the range of target monitoring distances corresponding to the target area marker matches the target position information; and
an area marker display module 1004, configured to determine a display mode of the target area marker according to height information in the target position information, and display the target area marker according to the display mode.

The present disclosure provides an apparatus for displaying position information, where an area monitoring marker is displayed on a graphical user interface, and the area monitoring marker includes a plurality of area markers. A target virtual object is determined, and target position information of the target virtual object in a game scene is obtained. A target area marker is determined from the plurality of area markers according to the target position information, a display mode of the target area marker is determined according to height information in the target position information, and the target area marker is displayed according to the display mode. In this method, the position information of a virtual object other than a first virtual object in the game scene is displayed through the target area marker of the plurality of area markers, and the distance, orientation and height between the virtual object and the first virtual object can be accurately provided, which is conducive to the player making decisions in the game according to the distance and orientation of the virtual object, thereby improving the game experience of the player.

Further, the target position information obtaining module is further configured to: determine a candidate virtual object that performs a preset game behavior, and obtain orientation information of the candidate virtual object, and when the orientation information of the candidate virtual object is within the monitored area, determine the candidate virtual object as the target virtual object.

Further, the target position information obtaining module is further configured to: obtain absolute position information of the target virtual object relative to the game scene, or, obtain relative position information of the target virtual object relative to the first virtual object; calculate the distance information, orientation information, and height information between the target virtual object and the first virtual object according to the absolute position information or the relative position information; and determine the distance information, the orientation information, and the height information as the target position information.

Further, the area marker determination module is further configured to determine the target area marker from the plurality of area markers according to distance information and orientation information in the target position information.

Further, the above plurality of area markers include a first area marker; the above area marker determination module is further configured to: if the distance information indicates that the horizontal distance between the target virtual object and the first virtual object is less than or equal to a first preset distance, determine the first area marker as the target area marker.

Further, the plurality of area markers includes a plurality of second area markers, and each of the second area markers has a different relative direction to a center point of the first area marker; and the area marker determination module is further configured to: if the distance information indicates that the horizontal distance between the target virtual object and the first virtual object is greater than the first preset distance and less than or equal to a second preset distance, determine the second area markers as first candidate area markers; and if the orientation information indicates that an orientation of the target virtual object relative to the first virtual object is a first direction, determine the target area marker that matches the first direction from the first candidate area markers.

Further, the plurality of area markers includes a plurality of third area markers, and each of the third area markers has a different relative direction to a center point of the first area marker; and the area marker determination module is further configured to: if the distance information indicates that the horizontal distance between the target virtual object and the first virtual object is greater than a second preset distance and less than or equal to a third preset distance, determine the third area markers as second candidate area markers; and if the orientation information indicates that an orientation of the target virtual object relative to the first virtual object is a second direction, determine the target area marker that matches the second direction from the second candidate area markers.

Further, the area monitoring marker is a first circle, a first area marker in the plurality of area markers is a second circle, a radius of the first circle is greater than a radius of the second circle, and a center of the first circle is at a same position as a center of the second circle; second area markers in the plurality of area markers are sectors divided from a circular ring between the first circle and the second circle; and third area markers in the plurality of area markers are outer lines of the first circle.

Further, the area monitoring marker is provided with a reference position marker, and the reference position marker corresponds to the first virtual object; and the area marker display module is further configured to: determine the display mode of the target area marker according to the height information in the target position information, and display a first position marker of the target virtual object in the target area marker according to the display mode, where the first position marker is used to indicate the target position information of the target virtual object relative to the first virtual object, and a relative position of the first position marker to the reference position marker matches a relative position of the target virtual object to the first virtual object.

Further, the target area marker is a first area marker, and the reference position marker is located at the first area marker; and the area marker display module is further configured to: if the height information is zero, and a relationship between the target virtual object and the first virtual object is a hostile relationship, fill the target area marker with a first preset color that is highlighted at an edge and transparent to the interior; and if the height information is not zero, and the relationship between the target virtual object and the first virtual object is the hostile relationship, display a line with the first preset color at the edge of the target area marker.

Further, the target area marker is a second area marker; and the area marker display module is further configured to: if the height information is zero, and a relationship between the target virtual object and the first virtual object is a hostile relationship, fill the target area marker with a first preset color that is highlighted at an outer edge and transparent to the interior; and if the height information is not zero, and the relationship between the target virtual object and the first virtual object is the hostile relationship, fill the target area marker with the first preset color that is highlighted at an inner edge and transparent to the exterior.

Further, the target area marker is a third area marker; and the area marker display module is further configured to: if a relationship between the target virtual object and the first virtual object is a hostile relationship, fill the target area marker with a first preset color.

Further, the first preset color includes a plurality of different preset sub-colors, and the different preset sub-colors have different color depths, where the different preset sub-colors correspond to different distances between the first virtual object and the target virtual object within the range of target monitoring distances corresponding to the target area marker.

Further, the area marker display module is further configured to: if a relationship between the target virtual object and the first virtual object is a non-hostile relationship, determine a target position matching the target position information from the target area marker, and display a first object marker of the target virtual object at the target position.

Further, the area marker display module is further configured to: determine that the target virtual object is eliminated, and display a second object marker of the target virtual object at the target position.

Further, the above apparatus further includes a damage marker display module, which is configured to obtain position information and height information of the second virtual object in the game scene in response to the first virtual object being hit by the second virtual object in the game scene; and display a damage marker on the graphical user interface based on the orientation information and the height information, where the damage marker is used to indicate an orientation of the second virtual object, and the second virtual object is a virtual object that is in a hostile relationship with the first virtual object.

Further, the above damage marker display module is further configured to: determine relative orientation information and relative height information of the second virtual object relative to the first virtual object according to the orientation information and the height information; determine a designated area marker that matches the relative orientation information from a plurality of area markers of the area monitoring marker according to the relative position information and the relative height information; and determine a display mode of the damage marker according to the relative height information, and displaying the damage marker in an external area corresponding to the designated area marker according to the display mode.

Further, the above damage marker display module is further configured to: if the relative height information is zero, determine that the display mode of the damage marker is a first display mode, and display the damage marker in the external area corresponding to the designated area marker according to the first display mode, where the first display mode indicates that a height of the second virtual object relative to the first virtual object is zero; if the relative height information is greater than zero, determine that the display mode of the damage marker is a second display mode, and display the damage marker in the external area corresponding to the designated area marker according to the second display mode, where the second display mode indicates that the height of the second virtual object relative to the first virtual object is greater than zero; and if the relative height information is less than zero, determine that the display mode of the damage marker is a third display mode, and display the damage marker in the external area corresponding to the designated area marker according to the third display mode, where the third display mode indicates that the height of the second virtual object relative to the first virtual object is less than zero.

Further, the area markers include a plurality of second area markers and a plurality of third area markers, and the apparatus further includes an increasing module, which is configured to: in response to the first virtual object obtaining a designated virtual item, increase the number of the second area markers and the number of the third area markers, or increasing the monitoring range parameter, where the number of the second area markers is the same as the number of the third area markers.

The apparatus for displaying position information provided by the embodiment of the present disclosure has the same technical features as the method for displaying position information provided by the above-mentioned embodiment, and therefore can solve the same technical problems and achieve the same technical effects.

This embodiment further provides an electronic device, including a processor and a memory, where the memory stores computer executable instructions that can be executed by the processor, and the processor executes the computer executable instructions to implement the above method for displaying position information. The electronic device may be a server or a terminal device.

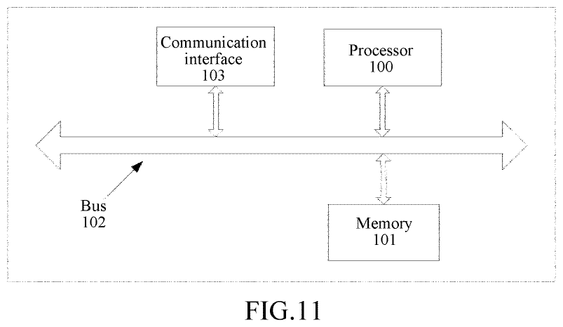

As shown in FIG. 11, the electronic device includes a processor 100 and a memory 101. The memory 101 stores computer executable instructions that can be executed by the processor 100. The processor 100 executes the computer executable instructions to implement the above method for displaying position information, and the method includes the following steps:
displaying an area monitoring marker on the graphical user interface, where a monitored area corresponding to the area monitoring marker is a spatial area of the game scene determined according to a current position of the first virtual object and a monitoring range parameter, the area monitoring marker includes a plurality of area markers, and the area marker corresponds to a scene area within a range of target monitoring direction and a range of target monitoring distance in the game scene; determining a target virtual object, and obtaining target position information of the target virtual object in the game scene, where the target virtual object is a virtual object other than the first virtual object in the game scene; determining a target area marker from the plurality of area markers according to the target position information, where a scene area within the range of target monitoring directions and the range of target monitoring distances corresponding to the target area marker matches the target position information; and determining a display mode of the target area marker according to height information in the target position information, and displaying the target area marker according to the display mode. In this method, the position information of a virtual object other than a first virtual object in the game scene is displayed through the target area marker of the plurality of area markers, and the distance, orientation and height between the virtual object and the first virtual object can be accurately provided, which is conducive to the player making decisions in the game according to the distance and orientation of the virtual object, thereby improving the game experience of the player.

The step of determining the target virtual object includes: determining a candidate virtual object that performs a preset game behavior, and obtaining orientation information of the candidate virtual object; when the orientation information of the candidate virtual object is within the monitored area, determining the candidate virtual object as the target virtual object.

The step of obtaining the target position information of the target virtual object in the game scene includes: obtaining absolute position information of the target virtual object relative to the game scene; or, obtaining relative position information of the target virtual object relative to the first virtual object; calculating distance information, orientation information, and height information between the target virtual object and the first virtual object based on the absolute position information or the relative position information; and determining the distance information, the orientation information, and the height information as the target position information.

The step of determining the target area marker from the plurality of area markers according to the target position information includes: determining the target area marker from the plurality of area markers according to the distance information and the orientation information in the target position information.

The plurality of area markers includes a first area marker; and the step of determining the target area marker from the plurality of area markers according to the distance information and the orientation information in the target position information includes: if the distance information indicates that a horizontal distance between the target virtual object and the first virtual object is less than or equal to a first preset distance, determining the first area marker as the target area marker.

The plurality of area markers includes a plurality of second area markers, and each of the second area markers has a different relative direction to a center point of the first area marker; and the step of determining the target area marker from the plurality of area markers according to the distance information and the orientation information in the target position information includes: if the distance information indicates that the horizontal distance between the target virtual object and the first virtual object is greater than the first preset distance and less than or equal to a second preset distance, determining the second area markers as first candidate area markers; and if the orientation information indicates that an orientation of the target virtual object relative to the first virtual object is a first direction, determining the target area marker that matches the first direction from the first candidate area markers.

The plurality of area markers includes a plurality of third area markers, and each of the third area markers has a different relative direction to a center point of the first area marker; and the step of determining the target area marker from the plurality of area markers according to the distance information and the orientation information in the target position information includes: if the distance information indicates that the horizontal distance between the target virtual object and the first virtual object is greater than the second preset distance and less than or equal to a third preset distance, determining the third area markers as second candidate area markers; and if the orientation information indicates that an orientation of the target virtual object relative to the first virtual object is a second direction, determining the target area marker that matches the second direction from the second candidate area markers.

The area monitoring marker is a first circle, a first area marker of the plurality of area markers is a second circle, a radius of the first circle is greater than a radius of the second circle, and a center of the first circle is at a same position as a center of the second circle; second area markers of the plurality of area markers are sectors divided from a circular ring between the first circle and the second circle; and third area markers of the plurality of area markers are outer lines of the first circle.

The area monitoring marker is provided with a reference position marker, and the reference position marker corresponds to the first virtual object; and a step of determining the display mode of the target area marker according to the height information in the target position information, and displaying the target area marker according to the display mode includes: determining the display mode of the target area marker according to the height position information in the target position information, and displaying a first position marker of the target virtual object in the target area marker according to the display mode, where the first position marker is used to indicate the target position information of the target virtual object relative to the first virtual object, and a relative position of the first position marker to the reference position marker matches a relative position of the target virtual object to the first virtual object.

The target area marker is a first area marker, and the reference position marker is located at the first area marker; and a step of determining the display mode of the target area marker according to the height information in the target position information, and displaying the first position marker of the target virtual object in the target area marker according to the display mode includes: if the height position is zero, and a relationship between the target virtual object and the first virtual object is a hostile relationship, filling the target area marker with a first preset color that is highlighted at an edge and transparent to the interior; and if the height information is not zero, and the relationship between the target virtual object and the first virtual object is the hostile relationship, displaying a line with the first preset color at the edge of the target area marker.

The target area marker is a second area marker; and a step of determining the display mode of the target area marker according to the height information in the target position information, and displaying the first position marker of the target virtual object in the target area marker according to the display mode includes: if the height information is zero, and a relationship between the target virtual object and the first virtual object is a hostile relationship, filling the target area marker with a first preset color that is highlighted at an outer edge and transparent to the interior; and if the height information is not zero, and the relationship between the target virtual object and the first virtual object is the hostile relationship, filling the target area marker with the first preset color that is highlighted at an inner edge and transparent to the exterior.

The target area marker is a third area marker; and a step of determining the display mode of the target area marker according to the height information in the target position information, and displaying the first position marker of the target virtual object in the target area marker according to the display mode includes: if a relationship between the target virtual object and the first virtual object is a hostile relationship, filling the target area marker with a first preset color.

The first preset color includes a plurality of different preset sub-colors, and the different preset sub-colors have different color depths, where the different preset sub-colors correspond to different distances between the first virtual object and the target virtual object within the range of target monitoring distances corresponding to the target area marker.

The step of displaying the first position marker of the target virtual object in the target area marker includes: if a relationship between the target virtual object and the first virtual object is a non-hostile relationship, determining a target position matching the target position information from the target area marker, and displaying a first object marker of the target virtual object at the target position.

The step of displaying the first object marker of the target virtual object at the target position includes: determining that the target virtual object is eliminated, and displaying a second object marker of the target virtual object at the target position.

The above method further includes: in response to the first virtual object being hit by a second virtual object in the game scene, obtaining orientation information and height information of the second virtual object in the game scene; and displaying a damage marker on the graphical user interface based on the orientation information and the height information, where the damage marker is used to indicate an orientation of the second virtual object, and the second virtual object is a virtual object that is in a hostile relationship with the first virtual object.

The above step of displaying the damage marker on the graphical user interface based on the orientation information and the height information includes: determining relative orientation information and relative height information of the second virtual object relative to the first virtual object according to the orientation information and the height information; determining a designated area marker that matches the relative orientation information from a plurality of area markers of the area monitoring marker according to the relative position information and the relative height information; and determining a display mode of the damage marker according to the relative height information, and displaying the damage marker in an external area corresponding to the designated area marker according to the display mode.

The damage marker is a three-dimensional conical marker; and a step of determining the display mode of the damage marker according to the relative height information, and displaying the damage marker in the external area corresponding to the designated area marker according to the display mode includes: if the relative height information is zero, determining that the display mode of the damage marker is a first display mode, and displaying the damage marker in the external area corresponding to the designated area marker according to the first display mode, where the first display mode indicates that a height of the second virtual object relative to the first virtual object is zero; if the relative height information is greater than zero, determining that the display mode of the damage marker is a second display mode, and displaying the damage marker in the external area corresponding to the designated area marker according to the second display mode, where the first display mode indicates that the height of the second virtual object relative to the first virtual object is greater than zero; and if the relative height information is less than zero, determining that the display mode of the damage marker is a third display mode, and displaying the damage marker in the external area corresponding to the designated area marker according to the third display mode, where the third display mode indicates that the height of the second virtual object relative to the first virtual object is less than zero.

The area markers include a plurality of second area markers and a plurality of third area markers, and the method further includes: in response to the first virtual object obtaining a designated virtual item, increasing the number of the second area markers and the third area markers, or increasing the monitoring range parameter, where the number of the second area markers is the same as the number of the third area markers.

Furthermore, the electronic device shown in FIG. 11 further includes a bus 102 and a communication interface 103, and the processor 100, the communication interface 103 and the memory 101 are connected via the bus 102.

The memory 101 may include a high-speed random access memory (RAM), and may also include a non-volatile memory, such as at least one disk memory. The communication connection between the system network element and at least one other network element is realized through at least one communication interface 103 (which may be wired or wireless), and the Internet, wide area network, local area network, metropolitan area network, etc. may be used. The bus 102 may be an ISA bus, a PCI bus or an EISA bus, etc. The bus may be divided into an address bus, a data bus, a control bus, etc. For ease of representation, only one bidirectional arrow is used in FIG. 11, but it does not mean that there is only one bus or one type of bus.

The processor 100 may be an integrated circuit chip with signal processing capabilities. In the implementation process, each step of the above method may be completed by the hardware integrated logic circuit or instructions in software form in the processor 100. The above processor 100 may be a general-purpose processor, including a central processing unit (CPU), a network processor (NP), etc., it may also be a digital signal processor (DSP), an application specific integrated circuit (ASIC), a field-programmable gate array (FPGA), or other programmable logic devices, discrete gates or transistor logic devices, discrete hardware components, which can implement or execute the disclosed methods, steps and logic block diagrams in the embodiments of the present disclosure. The general-purpose processor may be a microprocessor or the processor may also be any conventional processor, etc. The steps of the method disclosed with reference to the embodiments of the present disclosure may be directly embodied as being executed and completed by a hardware decoding processor, or may be embodied as being executed and completed by a combination of hardware and software modules in a decoding processor. The software module may be located in a random access memory, flash memory, read-only memory, programmable read-only memory or electrically erasable programmable memory, registers, and other mature storage media in the art. The storage medium is located in the memory 101, and the processor 100 reads the information in the memory 101 and completes the steps of the methods of the above embodiments in conjunction with its hardware.

This embodiment further provides a computer-readable storage medium, which stores computer executable instructions. When the computer executable instructions are called and executed by a processor, the computer executable instructions prompt the processor to implement the above method for displaying position information, and the method specifically includes:
displaying an area monitoring marker on the graphical user interface, where a monitored area corresponding to the area monitoring marker is a spatial area of the game scene determined according to a current position of the first virtual object and a monitoring range parameter, the area monitoring marker includes a plurality of area markers, and the area marker corresponds to a scene area within a range of target monitoring direction and a range of target monitoring distance in the game scene; determining a target virtual object, and obtaining target position information of the target virtual object in the game scene, where the target virtual object is a virtual object other than the first virtual object in the game scene; determining a target area marker from the plurality of area markers according to the target position information, where a scene area within the range of target monitoring directions and the range of target monitoring distances corresponding to the target area marker matches the target position information; and determining a display mode of the target area marker according to height information in the target position information, and displaying the target area marker according to the display mode. In this method, the position information of a virtual object other than a first virtual object in the game scene is displayed through the target area marker of the plurality of area markers, and the distance, orientation and height between the virtual object and the first virtual object can be accurately provided, which is conducive to the player making decisions in the game according to the distance and orientation of the virtual object, thereby improving the game experience of the player.

The step of determining the target virtual object includes: determining a candidate virtual object that performs a preset game behavior, and obtaining orientation information of the candidate virtual object; when the orientation information of the candidate virtual object is within the monitored area, determining the candidate virtual object as the target virtual object.

The step of obtaining the target position information of the target virtual object in the game scene includes: obtaining absolute position information of the target virtual object relative to the game scene; or, obtaining relative position information of the target virtual object relative to the first virtual object; calculating distance information, orientation information, and height information between the target virtual object and the first virtual object based on the absolute position information or the relative position information; and determining the distance information, the orientation information, and the height information as the target position information.

The step of determining the target area marker from the plurality of area markers according to the target position information includes: determining the target area marker from the plurality of area markers according to the distance information and the orientation information in the target position information.

The plurality of area markers includes a first area marker; and the step of determining the target area marker from the plurality of area markers according to the distance information and the orientation information in the target position information includes: if the distance information indicates that a horizontal distance between the target virtual object and the first virtual object is less than or equal to a first preset distance, determining the first area marker as the target area marker.

The plurality of area markers includes a plurality of second area markers, and each of the second area markers has a different relative direction to a center point of the first area marker; and the step of determining the target area marker from the plurality of area markers according to the distance information and the orientation information in the target position information includes: if the distance information indicates that the horizontal distance between the target virtual object and the first virtual object is greater than the first preset distance and less than or equal to a second preset distance, determining the second area markers as first candidate area markers; and if the orientation information indicates that an orientation of the target virtual object relative to the first virtual object is a first direction, determining the target area marker that matches the first direction from the first candidate area markers.

The plurality of area markers includes a plurality of third area markers, and each of the third area markers has a different relative direction to a center point of the first area marker; and the step of determining the target area marker from the plurality of area markers according to the distance information and the orientation information in the target position information includes: if the distance information indicates that the horizontal distance between the target virtual object and the first virtual object is greater than the second preset distance and less than or equal to a third preset distance, determining the third area markers as second candidate area markers; and if the orientation information indicates that an orientation of the target virtual object relative to the first virtual object is a second direction, determining the target area marker that matches the second direction from the second candidate area markers.

The area monitoring marker is a first circle, a first area marker of the plurality of area markers is a second circle, a radius of the first circle is greater than a radius of the second circle, and a center of the first circle is at a same position as a center of the second circle; second area markers of the plurality of area markers are sectors divided from a circular ring between the first circle and the second circle; and third area markers of the plurality of area markers are outer lines of the first circle.

The area monitoring marker is provided with a reference position marker, and the reference position marker corresponds to the first virtual object; and a step of determining the display mode of the target area marker according to the height information in the target position information, and displaying the target area marker according to the display mode includes: determining the display mode of the target area marker according to the height position information in the target position information, and displaying a first position marker of the target virtual object in the target area marker according to the display mode, where the first position marker is used to indicate the target position information of the target virtual object relative to the first virtual object, and a relative position of the first position marker to the reference position marker matches a relative position of the target virtual object to the first virtual object.

The target area marker is a first area marker, and the reference position marker is located at the first area marker; and a step of determining the display mode of the target area marker according to the height information in the target position information, and displaying the first position marker of the target virtual object in the target area marker according to the display mode includes: if the height position is zero, and a relationship between the target virtual object and the first virtual object is a hostile relationship, filling the target area marker with a first preset color that is highlighted at an edge and transparent to the interior; and if the height information is not zero, and the relationship between the target virtual object and the first virtual object is the hostile relationship, displaying a line with the first preset color at the edge of the target area marker.

The target area marker is a second area marker; and a step of determining the display mode of the target area marker according to the height information in the target position information, and displaying the first position marker of the target virtual object in the target area marker according to the display mode includes: if the height information is zero, and a relationship between the target virtual object and the first virtual object is a hostile relationship, filling the target area marker with a first preset color that is highlighted at an outer edge and transparent to the interior; and if the height information is not zero, and the relationship between the target virtual object and the first virtual object is the hostile relationship, filling the target area marker with the first preset color that is highlighted at an inner edge and transparent to the exterior.

The target area marker is a third area marker; and a step of determining the display mode of the target area marker according to the height information in the target position information, and displaying the first position marker of the target virtual object in the target area marker according to the display mode includes: if a relationship between the target virtual object and the first virtual object is a hostile relationship, filling the target area marker with a first preset color.

The first preset color includes a plurality of different preset sub-colors, and the different preset sub-colors have different color depths, where the different preset sub-colors correspond to different distances between the first virtual object and the target virtual object within the range of target monitoring distances corresponding to the target area marker.

The step of displaying the first position marker of the target virtual object in the target area marker includes: if a relationship between the target virtual object and the first virtual object is a non-hostile relationship, determining a target position matching the target position information from the target area marker, and displaying a first object marker of the target virtual object at the target position.

The step of displaying the first object marker of the target virtual object at the target position includes: determining that the target virtual object is eliminated, and displaying a second object marker of the target virtual object at the target position.

The above method further includes: in response to the first virtual object being hit by a second virtual object in the game scene, obtaining orientation information and height information of the second virtual object in the game scene; and displaying a damage marker on the graphical user interface based on the orientation information and the height information, where the damage marker is used to indicate an orientation of the second virtual object, and the second virtual object is a virtual object that is in a hostile relationship with the first virtual object.

The above step of displaying the damage marker on the graphical user interface based on the orientation information and the height information includes: determining relative orientation information and relative height information of the second virtual object relative to the first virtual object according to the orientation information and the height information; determining a designated area marker that matches the relative orientation information from a plurality of area markers of the area monitoring marker according to the relative position information and the relative height information; and determining a display mode of the damage marker according to the relative height information, and displaying the damage marker in an external area corresponding to the designated area marker according to the display mode.

The damage marker is a three-dimensional conical marker; and a step of determining the display mode of the damage marker according to the relative height information, and displaying the damage marker in the external area corresponding to the designated area marker according to the display mode includes: if the relative height information is zero, determining that the display mode of the damage marker is a first display mode, and displaying the damage marker in the external area corresponding to the designated area marker according to the first display mode, where the first display mode indicates that a height of the second virtual object relative to the first virtual object is zero; if the relative height information is greater than zero, determining that the display mode of the damage marker is a second display mode, and displaying the damage marker in the external area corresponding to the designated area marker according to the second display mode, where the first display mode indicates that the height of the second virtual object relative to the first virtual object is greater than zero; and if the relative height information is less than zero, determining that the display mode of the damage marker is a third display mode, and displaying the damage marker in the external area corresponding to the designated area marker according to the third display mode, where the third display mode indicates that the height of the second virtual object relative to the first virtual object is less than zero.

The area markers include a plurality of second area markers and a plurality of third area markers, and the method further includes: in response to the first virtual object obtaining a designated virtual item, increasing a number of the second area markers and the third area markers, or increasing the monitoring range parameter, where the number of the second area markers is the same as the number of the third area markers.

The method, apparatus, electronic device and computer program product of the system for displaying position information provided in the embodiments of the present disclosure include a computer-readable storage medium storing program codes thereon. The instructions included in the program code may be used to execute the methods described in the previous method embodiments. The specific implementation may refer to the method embodiments, which will not be repeated herein.

Those skilled in the art can clearly understand that, for the convenience and brevity of description, the specific working process of the system and apparatus described above may refer to the corresponding process in the aforementioned method embodiments, and will not be repeated herein.

In addition, in the description of the embodiments of the present disclosure, unless otherwise explicitly specified and limited, the terms “installed”, “connected”, and “connection” should be understood in a broad sense, for example, it may be a fixed connection, a detachable connection, or an integral connection; it may be a mechanical connection or an electrical connection; it may be a direct connection or indirect connection through an intermediate medium, or it may be the internal communication of two components. For those skilled in the art, the specific meanings of the above terms in the present disclosure may be understood according to specific circumstances.

If the functions are implemented in the form of software functional units and sold or used as independent products, they can be stored in a computer-readable storage medium. Based on this understanding, the essence of the technical solution, or the part that contributes to the prior art or the part of the technical solution of the present disclosure, may be embodied in the form of a software product. The computer software product is stored in a storage medium, which includes several instructions to enable a computer device (which may be a personal computer, a server, or a network device, etc.) to perform all or part of the steps of the method described in each embodiment of the present disclosure. The aforementioned storage medium includes: a USB flash drive, a removable hard disk, a read-only memory (ROM), a random access memory (RAM), a disk or optical disk, and other media that can store program codes.

In the description of the present disclosure, it should be noted that the orientation or positional relationship indicated by the terms “center”, “upper”, “lower”, “left”, “right”, “vertical”, “horizontal”, “inner”, “outer”, etc., are based on the orientation or positional relationship shown in the accompanying drawings, and are only for the ease of describing the present disclosure and simplifying the description, rather than indicating or implying that the apparatus or element referred to must have a specific orientation, be constructed and operated in a specific orientation, and therefore cannot be understood as a limitation of the present disclosure. In addition, the terms “first”, “second”, and “third” are used for descriptive purposes only, and cannot be understood as indicating or implying relative importance.

Finally, it should be noted that the above embodiments are only specific implementation manners of the present disclosure, which are used to illustrate the technical solutions of the present disclosure, rather than to limit them. The protection scope of the present disclosure is not limited thereto. Although the present disclosure is described in detail with reference to the above embodiments, those skilled in the art should understand that any technician familiar with the technical field can still modify the technical solutions recorded in the fore going embodiments, or easily think of changes, or make equivalent replacements for some of the technical features therein within the technical scope disclosed in the present disclosure, and these modifications, changes or replacements do not make the essence of the corresponding technical solutions deviate from the spirit and scope of the technical solutions of the embodiments of the present disclosure, and should be included in the protection scope of the present disclosure. Therefore, the protection scope of the present disclosure should be subject to the protection scope of the claims.

1. A method for displaying position information, wherein the method comprises:
displaying an area monitoring marker on a graphical user interface displayed by a terminal device, wherein the graphical user interface comprises a scene screen of a game scene and a first virtual object located in the game scene, the first virtual object is a virtual object controlled by the terminal device, a monitored area corresponding to the area monitoring marker is a spatial area of the game scene determined according to a current position of the first virtual object and a monitoring range parameter, the area monitoring marker comprises a plurality of area markers, and the area marker corresponds to a scene area within a range of target monitoring direction and a range of target monitoring distance in the game scene;
determining a target virtual object, and obtaining a target position of the target virtual object in the game scene, wherein the target virtual object is a virtual object other than the first virtual object in the game scene;
determining a target area marker from the plurality of area markers according to the target position, wherein a scene area within the range of target monitoring directions and the range of target monitoring distances corresponding to the target area marker matches the target position; and
determining a display mode of the target area marker according to a height of the target position, and displaying the target area marker according to the display mode.

2. The method according to claim 1, wherein determining the target virtual object comprises:
determining a candidate virtual object that performs a preset game behavior, and obtaining an orientation of the candidate virtual object; and
in response to the orientation of the candidate virtual object being within the monitored area, determining the candidate virtual object as the target virtual object.

3. The method according to claim 1, wherein the target position is an absolute position of the target virtual object relative to the game scene, and the absolute position comprises at least one of following: a horizontal position or a height position; or
the target position is a relative position of the target virtual object relative to the first virtual object, and the relative position comprises at least one of following: a relative distance, a relative orientation or a relative height.

4. The method according to claim 1, wherein determining the target area marker from the plurality of area markers according to the target position comprises:
determining the target area marker from the plurality of area markers according to a horizontal position, or a relative distance and a relative orientation of the target position.

5. The method according to claim 4, wherein the plurality of area markers comprises a first area marker; and
wherein determining the target area marker from the plurality of area markers according to the horizontal position, or the relative distance and the relative orientation of the target position comprises:
in response to the horizontal position or the relative distance indicating that a horizontal distance between the target virtual object and the first virtual object is less than or equal to a first preset distance, determining the first area marker as the target area marker.

6. The method according to claim 4, wherein the plurality of area markers comprises a plurality of second area markers, and each of the second area markers has a different relative direction to a center point of the first area marker; and
wherein determining the target area marker from the plurality of area markers according to the horizontal position, or the relative distance and the relative orientation of the target position comprises:
in response to the horizontal position or the relative distance indicating that a horizontal distance between the target virtual object and the first virtual object is greater than a first preset distance and less than or equal to a second preset distance, determining the second area markers as first candidate area markers; and
in response to the horizontal position or the relative orientation indicating that an orientation of the target virtual object relative to the first virtual object is a first direction, determining the target area marker that matches the first direction from the first candidate area markers.

7. The method according to claim 4, wherein the plurality of area markers comprises a plurality of third area markers, and each of the third area markers has a different relative direction to a center point of the first area marker; and
wherein determining the target area marker from the plurality of area markers according to the horizontal position, or the relative distance and the relative orientation of the target position comprises:
in response to the horizontal position or the relative distance indicating that a horizontal distance between the target virtual object and the first virtual object is greater than a second preset distance and less than or equal to a third preset distance, determining the third area markers as second candidate area markers; and
in response to the horizontal position or the relative orientation indicating that an orientation of the target virtual object relative to the first virtual object is a second direction, determining the target area marker that matches the second direction from the second candidate area markers.

8. The method according to claim 1, wherein the area monitoring marker is a first circle, a first area marker in the plurality of area markers is a second circle, a radius of the first circle is greater than a radius of the second circle, and a center of the first circle is at a same position as a center of the second circle;
second area markers in the plurality of area markers are sectors divided from a circular ring between the first circle and the second circle; and
third area markers in the plurality of area markers are outer lines of the first circle.

9. The method according to claim 1, wherein the area monitoring marker is provided with a reference position marker, and the reference position marker corresponds to the first virtual object; and
wherein determining the display mode of the target area marker according to the height of the target position, and displaying the target area marker according to the display mode comprises:
determining the display mode of the target area marker according to a height position or a relative height of the target position, and displaying a first position marker of the target virtual object in the target area marker according to the display mode, wherein the first position marker is used to indicate the target position of the target virtual object relative to the first virtual object, and a relative position of the first position marker to the reference position marker matches a relative position of the target virtual object to the first virtual object.

10. The method according to claim 9, wherein the target area marker is a first area marker, and the reference position marker is located at the first area marker; and
wherein determining the display mode of the target area marker according to the height position or the relative height of the target position, and displaying the first position marker of the target virtual object in the target area marker according to the display mode comprises:
in response to the height position or the relative height indicating that a height difference between the target virtual object and the first virtual object is zero, and a relationship between the target virtual object and the first virtual object being a hostile relationship, filling the target area marker with a first preset color that is highlighted at an edge and transparent to the interior; and
in response to the height position or the relative height indicating that the height difference between the target virtual object and the first virtual object is not zero, and the relationship between the target virtual object and the first virtual object being the hostile relationship, displaying a line with the first preset color at the edge of the target area marker.

11. The method according to claim 9, wherein the target area marker is a second area marker; and
wherein determining the display mode of the target area marker according to the height position or the relative height of the target position, and displaying the first position marker of the target virtual object in the target area marker according to the display mode comprises:
in response to the height position or the relative height indicating that a height difference between the target virtual object and the first virtual object is zero, and a relationship between the target virtual object and the first virtual object being a hostile relationship, filling the target area marker with a first preset color that is highlighted at an outer edge and transparent to the interior; and
in response to the height position or the relative height indicating that the height difference between the target virtual object and the first virtual object is not zero, and the relationship between the target virtual object and the first virtual object being the hostile relationship, filling the target area marker with the first preset color that is highlighted at an inner edge and transparent to the exterior.

12. The method according to claim 9, wherein the target area marker is a third area marker; and
wherein determining the display mode of the target area marker according to the height position or the relative height of the target position, and displaying the first position marker of the target virtual object in the target area marker according to the display mode comprises:
in response to a relationship between the target virtual object and the first virtual object being a hostile relationship, filling the target area marker with a first preset color.

13. The method according to claim 10, wherein the first preset color comprises a plurality of different preset sub-colors, and the different preset sub-colors have different color depths;
wherein the different preset sub-colors correspond to different distances between the first virtual object and the target virtual object within the range of target monitoring distances corresponding to the target area marker.

14. The method according to claim 9, wherein displaying the first position marker of the target virtual object in the target area marker comprises:
in response to a relationship between the target virtual object and the first virtual object being a non-hostile relationship, determining a target position matching the target position from the target area marker; and
displaying a first object marker of the target virtual object at the target position.

15. The method according to claim 14, wherein displaying the first object marker of the target virtual object at the target position comprises:
determining that the target virtual object is eliminated, and displaying a second object marker of the target virtual object at the target position.

16. The method according to claim 1, wherein the method further comprises:
in response to the first virtual object being hit by a second virtual object in the game scene, obtaining an orientation and a height of the second virtual object in the game scene; and
displaying a damage marker on the graphical user interface based on the orientation and the height, wherein the damage marker is used to indicate an orientation of the second virtual object, and the second virtual object is a virtual object that is in a hostile relationship with the first virtual object.

17. The method according to claim 16, wherein displaying the damage marker on the graphical user interface based on the orientation and the height comprises:
determining a relative orientation and a relative height of the second virtual object relative to the first virtual object according to the orientation and the height;
determining a designated area marker that matches the relative orientation from a plurality of area markers of the area monitoring marker according to the relative position and the relative height;
determining a display mode of the damage marker according to the relative height, and displaying the damage marker in an external area corresponding to the designated area marker according to the display mode.

18. The method according to claim 17, wherein the damage marker is a three-dimensional conical marker; and
wherein determining the display mode of the damage marker according to the relative height, and displaying the damage marker in the external area corresponding to the designated area marker according to the display mode comprises:
in response to the relative height being zero, determining that the display mode of the damage marker is a first display mode, and displaying the damage marker in the external area corresponding to the designated area marker according to the first display mode, wherein the first display mode indicates that a height of the second virtual object relative to the first virtual object is zero;
in response to the relative height being greater than zero, determining that the display mode of the damage marker is a second display mode, and displaying the damage marker in the external area corresponding to the designated area marker according to the second display mode, wherein the second display mode indicates that the height of the second virtual object relative to the first virtual object is greater than zero; and
in response to the relative height being less than zero, determining that the display mode of the damage marker is a third display mode, and displaying the damage marker in the external area corresponding to the designated area marker according to the third display mode, wherein the third display mode indicates that the height of the second virtual object relative to the first virtual object is less than zero.

19. The method according to claim 1, wherein the area markers comprise a plurality of second area markers and a plurality of third area markers, and the method further comprises:
in response to the first virtual object obtaining a designated virtual item, increasing numbers of the second area markers and the third area markers, or increasing the monitoring range parameter; wherein the number of the second area markers is the same as the number of the third area markers.

20. An apparatus for displaying position information, wherein the apparatus comprises:
a processor and a memory, wherein the memory stores computer-executable instructions capable of being executed by the processor, and the processor executes the computer-executable instructions to:
display an area monitoring marker on a graphical user interface displayed by a terminal device, wherein the graphical user interface comprises a scene screen of a game scene and a first virtual object located in the game scene, and the first virtual object is a virtual object controlled by the terminal device, a monitored area corresponding to the area monitoring marker is a spatial area of the game scene determined according to a current position and a monitoring range parameter of the virtual object, the area monitoring marker comprises a plurality of area markers, and the area marker corresponds to a scene area within a range of target monitoring direction and a range of target monitoring distance in the game scene;
determine a target virtual object, and obtain a target position of the target virtual object in the game scene, wherein the target virtual object is a virtual object other than the first virtual object in the game scene;
determine a target area marker from the plurality of area markers according to the target position, wherein a scene area within the range of target monitoring directions and the range of target monitoring distances corresponding to the target area marker matches the target position; and
determine a display mode of the target area marker according to a height of the target position, and display the target area marker according to the display mode.

21-22. (canceled)
